(19) United States
(12) Patent Application Publication
(10) Pub. No.: US 2023/0399718 A1
(43) Pub. Date: Dec. 14, 2023

(54) METHOD AND SYSTEM FOR PRODUCING LOW CARBON FERROCHROME FROM CHROMITE ORE AND LOW CARBON FERROCHROME PRODUCED THEREBY

(71) Applicant: MM Metals USA, LLC, Plymouth Meeting, PA (US)

(72) Inventors: Daniel Shaw, Haverford, PA (US); Adriaan Jacobus Van Der Merwe, Bloemfontein (ZA); Ottmar Aloys Lange, Satellite Beach, FL (US)

(21) Appl. No.: 18/229,467

(22) Filed: Aug. 2, 2023

Related U.S. Application Data
(63) Continuation-in-part of application No. 17/523,087, filed on Nov. 10, 2021.
Application No. 17/523,087 is a continuation of application No. PCT/US2020/035842, filed on Jun. 3, 2020.
Application No. PCT/US2020/035842 is a continuation of application No. 16/454,283, filed on Jun. 27, 2019, now Pat. No. 10,508,319.

(51) Int. Cl. C22B 5/04; C22C 33/04; C22C 38/18; C22B 1/24; C21D 9/00; C21D 8/12; C21D 1/74; C21D 6/00

(52) U.S. Cl. CPC C22B 5/04; C22C 33/04; C22C 38/18; C22B 1/24; C21D 9/0025; C21D 8/1205; C21D 1/74; C21D 9/0068; C21D 6/002

(57) ABSTRACT

A method and system for recovering a high yield of low carbon ferrochrome metal from chromite ore and low carbon ferrochrome metal produced by the method. A thermochemistry calculated mixture of feed materials including aluminum granules, burnt limestone, and chromite ore are provided into a DC plasma arc furnace. The aluminum granules are produced from aluminum scrap. The feed materials are heated upon entering the furnace free board through a feed mix injection system, whereupon the aluminum in the aluminum granules produces an exothermic reaction reducing the chromium oxide and iron oxides in the chromite ore to produce molten low carbon ferrochrome metal with molten slag floating thereon. The molten low carbon ferrochrome metal is extracted, solidified into ingots, crushed into coarse pieces or fines of low carbon ferrochrome metal product. The molten slag is extracted, quenched and solidified into slag particles product.

### CROSS-REFERENCE TO RELATED APPLICATIONS

This application is a Continuation-In-Part of U.S. patent application Ser. No. 17/523,087, filed on Nov. 10, 2021, entitled METHOD AND SYSTEM FOR PRODUCING LOW CARBON FERROCHROME FROM CHROMITE ORE, which in turn is a Continuation of PCT/US2020/035842, filed on Jun. 3, 2020, entitled METHOD AND SYSTEM FOR PRODUCING LOW CARBON FERROCHROME FROM CHROMITE ORE AND LOW CARBON FERROCHROME PRODUCED THEREBY, and which claims the benefit under 35 U.S.C. § 120 of U.S. patent application Ser. No. 16/454,283, filed on Jun. 27, 2019, entitled METHOD AND SYSTEM FOR PRODUCING LOW CARBON FERROCHROME FROM CHROMITE ORE AND LOW CARBON FERROCHROME PRODUCED THEREBY, now U.S. Pat. No. 10,508,319, issued on Dec. 17, 2019, the disclosures of all of which applications are incorporated by reference herein.

### FIELD OF THE INVENTION

This invention relates generally to alloy forming and more particularly to methods and systems for producing low carbon ferrochrome from chromite ore and low carbon ferrochrome produced thereby.

### SPECIFICATION

### Background of the Invention

Low carbon ferrochrome (“LC FeCr”) is a niche product having several uses, the most common of which being for “trimming adjustment” of high chromium content steels in ladle furnaces where introduction of carbon from high carbon ferrochrome is unacceptable. There are several grades of LC FeCr with varying amounts of carbon, silicon and nitrogen and which are produced from chromite ores. LC FeCr may be manufactured from chromite ore by several processes such as the Perrin process and the Duplex process, the Simplex process, etc., all of which use silicon as reductant in the form of ferro silicon (FeSi) and silicon metal (SiMet). Aluminum has been used as an alternative reducing agent instead of using silicon. By using aluminum as the reducing agent, instead of using carbon, it is possible to produce the metal alloy low carbon ferrochrome which contains about 70% chromium. However, the conventional carbon reductant smelting processes for producing LC FeCr from chromite leave much to be desired from the standpoints of economic and environmental protection.

Thus, a need exists for a system and method of producing low carbon ferrochrome from chromite ore which can be carried out economically and is environmentally friendly. The subject invention addresses that need.

### BRIEF SUMMARY OF THE INVENTION

One aspect of this invention is a method for recovering low carbon ferrochrome metal from chromite ore comprising feeding a mixture of feed materials comprising aluminum granules, burnt lime, and chromite ore into a DC plasma arc furnace. The chromite ore contains chromium oxide and iron oxides. The feed materials are in a proportion as determined by thermochemical calculations for reduction of the chromium oxide and iron oxides to form low carbon ferrochrome metal. The feed materials are heated in the DC plasma arc furnace to a temperature in the range of approximately 1,660\ddot{ }8 C to 1850\ddot{ } 8 C wherein the aluminum in the aluminum granules acts as a reducing agent to produce an exothermic reaction reducing the chromium oxide and iron oxides in the chromite ore to produce a bath of molten low carbon ferrochrome metal with molten slag floating on top of the molten low carbon ferrochrome metal. The molten low carbon ferrochrome is extracted from the DC plasma arc furnace.

In accordance with one preferred aspect of the method of this invention, the method additionally comprises extracting the molten slag from the DC plasma arc furnace and quenching or granulating the extracted molten slag into quenched slag conveyor particles or dry granulated particles of slag.

In accordance with another preferred aspect of the method of this invention, the DC plasma arc furnace includes a single transferred arc electrode.

In accordance with another preferred aspect of the method of this invention, the method is continuous.

In accordance with another preferred aspect of the method of this invention, the amount of aluminum granules used in the mixture of feed materials is determined through thermochemistry calculations for the chromite ore and iron oxides in the mixture of feed materials.

In accordance with another preferred aspect of the method of this invention, the method additionally comprises extracting molten slag from the DC plasma arc furnace at an outlet taphole.

In accordance with another preferred aspect of the method of this invention, Argon gas under pressure higher than atmospheric pressure is provided into the DC plasma arc furnace to prevent nitrogen and oxygen in air from entering into the plasma arc furnace.

In accordance with another preferred aspect of the method of this invention, Argon gas is used as a carrier gas to inject the feed mix materials into the DC plasma arc furnace.

In accordance with another preferred aspect of the method of this invention, Argon gas is heated in a furnace freeboard area upon entering the furnace and wherein the Argon gas is at a pressure of at least 0.2 inch of water column (50 Pa) above atmospheric pressure.

In accordance with another preferred aspect of the method of this invention, the heated Argon gas, after exiting the DC plasma arc furnace, is cooled, cleaned of solid materials and dust, other gaseous compounds, moisture, and recirculated for reuse into the DC plasma arc furnace.

In accordance with another preferred aspect of the method of this invention, pieces of low carbon ferrochrome are provided as a start-up metal in the chamber to form the bath of molten low carbon ferrochrome metal with molten slag floating on top of the molten low carbon ferrochrome metal.

Another aspect of this invention is low carbon ferrochrome produced by the method of this invention.

Another aspect of this invention is another method of producing a metal or metal alloy from feed materials located within a chamber in a DC plasma arc furnace, wherein the metal or metal alloy comprises low carbon ferrochrome. The method comprises providing a single electrically isolated graphite electrode or cathode in the DC plasma are furnace above the feed materials in the chamber. Controlled and controllable constant DC output power is applied to the electrically isolated graphite electrode or cathode from a DC plasma power supply to initiate a DC plasma arc from the graphite electrode or cathode to heat the feed materials in the chamber to produce a molten material bath in the chamber. The height of a bottom of the graphite electrode or cathode with respect to a surface of the molten material bath in the chamber is established until a desired power is established to produce the molten material bath in the chamber, with the power varying as a function of the feed rate of the feed mix materials. The molten material bath is stirred, with the stirring resulting from current flowing through the molten material bath producing Joule heating coupled with a magnetic effect of current flow through the molten bath to cause a local ripple effect or stirring motion in the molten material bath.

In accordance with one preferred aspect of the another method of this invention, the initiating of the DC plasma arc is accomplished by energizing the DC plasma power supply, lowering the graphite electrode or cathode into the furnace to contact a layer of the metal or metal alloy covering an electrical return copper anode that supports an electrically conductive refractory hearth containing the molten material bath, and selecting a start power for application by the DC plasma power supplies to cause a flow of current, whereupon the graphite electrode or cathode is raised until the desired power is established.

In accordance with another preferred aspect of the another method of this invention, that method additionally comprises providing pieces of the metal or metal alloy into the chamber where the molten material bath is located to form a molten layer of the metal or metal alloy in contact with the electrically conductive refractory hearth and return copper anode.

Another aspect of this invention is a metal or metal alloy produced by the another method of this invention.

Still another aspect of this invention is system for recovering low carbon ferrochrome metal from chromite ore. That system comprises a source of aluminum granules, a source of burnt lime, a source of chromite ore, a source of Argon gas, a conveyor, a conduit, and a direct current (DC) plasma arc furnace. The aluminum granules are low in magnesium and copper contents. The chromite ore contains chromium oxide and iron oxides. The conveyor is configured for carrying the aluminum granules, the burnt lime, and the chromite ore as a mix of feed materials to a chamber of a direct current (DC) plasma arc furnace via a feed materials injection system. The feed materials of the mix are in a proportion as determined by thermochemical calculations for reduction of the chromium oxide and iron oxides to form low carbon ferrochrome metal. The conduit is configured for carrying the Argon gas into the chamber via a feed materials injection system. The DC plasma arc furnace comprises a single transferred arc electrode or cathode electrode, an anode electrode, a direct current (DC) power supply, and a support holding the single transferred arc cathode electrode extending into the chamber, and over the anode electrode. The DC power supply is configured when the Argon gas is in the chamber to provide electrical power to the DC arc cathode electrode to produce a plasma arc thereby heating the feed materials in the chamber to a temperature in the range of approximately 1,660\ddot{ } 8 C to 1850\ddot{ } 8 C wherein the aluminum in the aluminum granules acts as a reducing agent to produce an exothermic reaction reducing the chromium oxide and iron oxides in the chromite ore to produce a molten material bath in the chamber above the anode electrode. The molten material bath comprises molten low carbon ferrochrome metal with molten slag floating on top of the molten low carbon ferrochrome metal.

In accordance with one preferred aspect of the system of this invention, the single transferred arc electrode or cathode is formed of graphite, and wherein the anode comprises an external anode system formed of copper and internal anode system formed of conductive refractory.

In accordance with another preferred aspect of the system of this invention, the DC plasma arc furnace is configured so that the Argon gas acts as a carrier gas to inject the mix of feed materials into the chamber.

In accordance with another preferred aspect of the system of this invention, the support holding the single transferred arc graphite electrode or cathode is configured to move the single transferred arc graphite electrode or cathode so that a portion extends into the chamber. The support is controllable for establishing the height of the single transferred arc graphite electrode or cathode with respect to the feed materials until a desired power is established to produce the molten material bath in the chamber. The power varies as a function of the feed rate at which the feed materials are introduced into the chamber by the Argon gas.

In accordance with another preferred aspect of the system of this invention, the DC plasma arc furnace comprises a taphole from which the molten low carbon ferrochrome metal can be caused to flow, and wherein the system additionally comprises an ingot caster with plural moulds configured for casting the molten low carbon ferrochrome metal into plural ingots.

In accordance with another preferred aspect of the system of this invention, the system additionally comprises a crusher apparatus for breaking and crushing the ingots into smaller pieces of low carbon ferrochrome metal.

In accordance with another preferred aspect of the system of this invention, the DC plasma arc furnace comprises a taphole from which the molten slag can be caused to flow, and wherein the system additionally comprises a water quencher configured for quenching the molten slag into quenched particles of slag.

In accordance with another preferred aspect of the system of this invention, the Argon gas is provided under pressure higher than atmospheric pressure into the chamber to prevent air ingress into the chamber.

In accordance with another preferred aspect of the system of this invention, the system additionally comprises apparatus configured for receipt of gases from the chamber to produce recycled Argon gas therefrom, and for providing the recycled Argon gas for reintroduction into the chamber.

In accordance with another preferred aspect of the system of this invention, the apparatus comprises a scrubber.

In accordance with another preferred aspect of the system of this invention, the arc furnace includes a hood and an associated conduit for collecting ejected furnace off-gas and other solid materials from the chamber and for carrying the solid materials to a dust recycling bin or other collector via the scrubber.

In accordance with another preferred aspect of the system of this invention, the system comprises a dryer for drying the chromite ore.

In accordance with another preferred aspect of the system of this invention, the system additionally comprises a main Argon supply tank, and a recycled Argon supply tank, each of which is configured to provide the Argon gas to the system.

In accordance with another preferred aspect of the system of this invention, the DC plasma arc furnace comprises a ferrochrome taphole from which the molten low carbon ferrochrome metal can be caused to flow, and a slag taphole from which the molten slag can be caused to flow, and wherein the DC plasma arc furnace is mounted on a tiltable support configured to allow the DC plasma arc furnace to tilt with respect to a vertical axis to enable controlled emptying of the chamber's contents.

### BRIEF DESCRIPTION OF SEVERAL VIEWS OF THE DRAWINGS

FIG. 1A is an illustrative diagram showing a portion of one exemplary embodiment of a system constructed in accordance with this invention for carrying out the methods of this invention to produce low carbon ferrochrome and a recoverable slag from chromite and other feed materials, which other feed materials contain aluminum in aluminum granules, e.g., granules produced from scrap aluminum, as the reductant, and burnt lime powder, as the flux, with the portion of the system for producing low carbon ferrochrome as shown in FIG. 1A including a particulates/solids transport subsystem for processing particulates/solid materials and showing the paths of such particulates/solids through the system;

FIG. 1B is another illustrative diagram showing the other portion of the exemplary system shown in FIG. 1A, e.g., a gas transport subsystem for handling of gases used in the system and the paths of such gases through the system.

FIG. 2 is an illustration of one portion of a system for producing one of the feed materials used in the system and method of this invention, i.e., the chromite ore;

FIG. 3 is an illustration, like that of FIG. 2, showing another portion of a system for producing another of the feed materials used in the system and method, i.e., the burnt lime, forming the recoverable slag produced by the system and method;

FIG. 4 is an illustration, like that of FIGS. 2-3, showing another portion of a system for producing another of the feed materials used in the system and method, i.e., the recycled solids forming the recoverable slag produced by the system and method;

FIG. 5 is an illustration, like that of FIGS. 2-4 showing another portion of system for producing the last of the feed materials used in the system and method, i.e., the scrap aluminum granules;

FIG. 6 is vertical sectional view of one exemplary DC plasma arc furnace forming a portion of the system of this invention and suitable for use in the methods of this invention;

FIG. 7 is an enlarged sectional view taken along line 7-7 of FIG. 6 (i.e., a top plan view of the furnace);

FIG. 8 is an isometric drawing illustration of the arc furnace shown in FIG. 6 during the stirring of the molten material bath in the furnace;

FIG. 9 is an enlarged cross-sectional view of a portion of the furnace, e.g., the molten slag taphole shown within the broken line circle designated by the reference number 9 in FIG. 6; and

FIG. 10 is an enlarged cross-sectional view of another portion of the furnace, e.g., the LC FeCr taphole shown within the broken line circle designated by the reference number 10 in FIG. 6.

### DETAILED DESCRIPTION OF ONE EXEMPLARY PREFERRED EMBODIMENT OF THE INVENTION

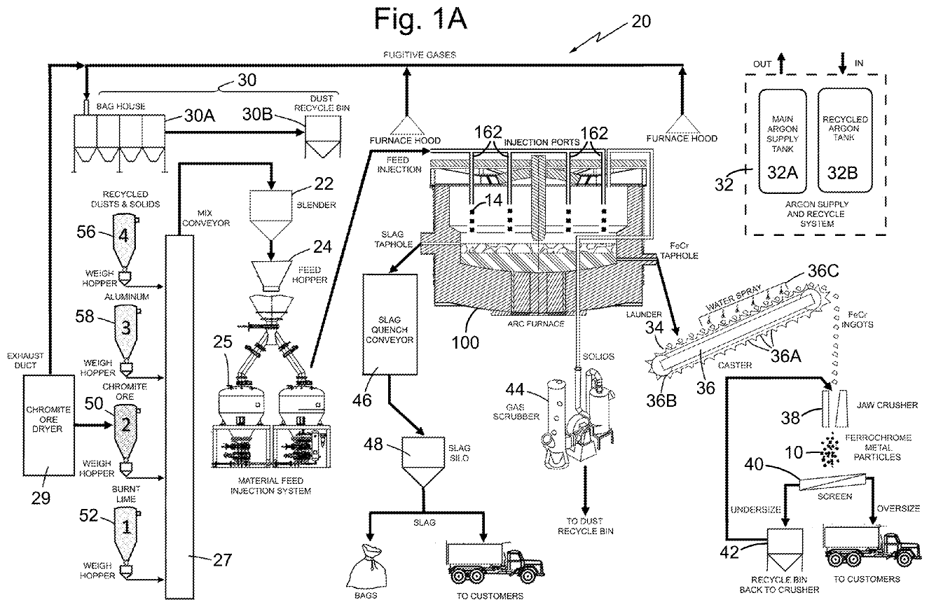

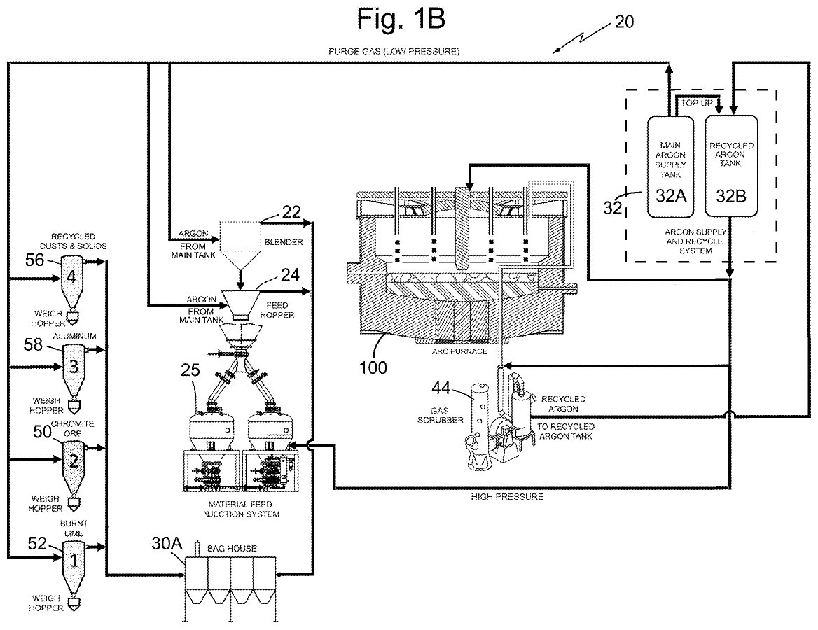

Referring now to the various figures of the drawing wherein like reference characters refer to like parts, there is shown in FIG. 1 one exemplary system 20 constructed in accordance with this invention for carrying out a method or process of this invention to produce low carbon ferrochrome ingots (referred to hereinafter as “ferrochrome product ingots”), and slag particles (referred to hereinafter as “slag product particles”) on a commercial scale using an aluminothermic process or technique (to be described in detail later). Following the crushing of the ferrochrome product ingots, into smaller pieces, these pieces are then suitable for various uses, e.g., the “trimming adjustment” of high chromium content steels in ladle furnaces. The quenched slag product particles are suitable for various uses, e.g., the making of cement and concrete.

Before describing the details of the system 20 and the methods of this invention it must be noted that any mention of other potential exemplary embodiments of such systems and methods as may be found in this application are being provided so that this disclosure will be thorough and will fully convey the scope of the invention to those who are skilled in the art. Numerous specific details are set forth hereinafter, such as examples of specific components, devices, and methods, to provide a thorough understanding of the present disclosure. It will be apparent to those skilled in the art that specific details need not be employed, that the exemplary system 20 as will be described later may be embodied in many different forms and that neither should be construed to limit the scope of the disclosure. In some cases, well-known processes, well-known device structures, and well-known technologies are not described in detail.

It should also be noted that the terminology used herein is for the purpose of describing the particular exemplary system 20 only and is not intended to be limiting. Moreover, as used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, com-ponent, region, layer or section without departing from the teachings of the example embodiments. Spatially relative terms, such as “inner,” “outer,” “beneath” “below” “lower” “above” “upper” and the like may be used herein for ease of description to’ describe one element or feature's relationship to another element(s) or feature(s) as illustrated in the figures. Spatially relative terms may be intended to encompass different orientations of the device in use or operation in addition to the orientation depicted in the figures. For example, if any component or structure shown in the figures is turned over, elements described as “below” or “beneath” other elements or features would then be oriented “above” the other elements or features. Thus, the example term “below” can encompass both an orientation of above and below.

The method/process of this invention basically entails feeding a mixture of feed materials comprising aluminum granules, burnt lime, and chromite ore into a direct current (DC) plasma arc furnace. The aluminum granules are produced from scrap aluminum grades that are low in magnesium and copper contents. The major oxides contained in the chromite ore are chromium oxide, iron oxides (FeO and Fe₂O₃), aluminum oxide, magnesium oxide, and silicon oxide. The feed materials are provided in a proportion determined through thermochemical calculations for reduction of the chromium oxide and iron oxides to form low carbon ferrochrome. The feeding of the feed mix materials into the DC plasma arc furnace is controlled in accordance with the active power input to the DC plasma arc furnace. The feed materials are injected into the plasma arc furnace containing molten ferrochrome and molten slag, wherein the aluminum in the aluminum granules acts as a reducing agent to produce an exothermic reaction, reducing the chromium oxide and iron oxides in the chromite ore to produce molten low carbon ferrochrome with molten slag, floating on top of the molten low carbon ferrochrome, due to density differences. The molten low carbon ferrochrome is intermittently tapped from the DC plasma arc furnace, whereas the slag is continuously tapped.

Preferably the method entails the continuous tapping of the molten slag from the DC plasma arc furnace and water quenching the tapped molten slag into quenched particles of slag. Also preferably, Argon gas under pressure higher than atmospheric pressure is provided into the DC plasma arc furnace to prevent air ingress into the plasma arc furnace and thus oxygen from entering the DC plasma arc furnace and to inject the raw feed mix input materials.

Turning now to FIGS. 1A and 1B, it can be seen that the system 20 basically comprises a feed mix materials blender 22, a blended feed mix day bin 24, a feed mix injection system 25, a direct current (DC) plasma arc furnace 100, a gas cleaning and recirculation system 30, an Argon supply and recycle system 32, a hot metal launder 34, a metal ingot caster 36, a metal ingot crusher 38, a screen 40, a ferrochrome particles recycling bin 42, a gas scrubber 44, a slag quench conveyor 46, and a quenched slag particles product collecting bin 48. The details of the construction and operation of those components will be described later. Suffice for now to state that the blender 22 is configured to receive the feed materials for producing low carbon ferrochrome metal product pieces and the quenched slag particles, each of which constitute valuable a product. The feed materials for the process are chromite ore 50, lime (e.g., burnt lime) 52, miscellaneous feed materials 54, recycled furnace off-gas dust/solid materials 56, and aluminum granules 58. The aluminum granules are produced on site from scrap aluminum or can be produced off-site from any type of aluminum scrap. Examples of such aluminum scrap are Mixed Low Copper scrap packages (for example scrap types 6000, 3000, 1000, 5000 series of scrap).

The feed materials are provided from respective feed bins to the blender 22 in a desired and controlled proportion to one another. Each of the feed material supply bins have a conventional level indicator (not shown) with an associated conventional and controllable Argon pneumatic transfer weigh hopper (not shown) to provide the desired amount of the individual feed materials to the blender 22. The Argon gas for the pneumatic transfer weigh hoppers is provided from the Argon supply and recycle system 32. That system basically comprises a Main Argon Supply Tank 32A and a Recycled Argon Supply Tank 32B and associated conduits (not shown). As best seen in FIG. 1B the Argon gas for the pneumatic transfer weigh hoppers is provided from Main Argon Supply Tank 32A. The transportation of the feed materials from their respective supply bins to the feed mix material blender 22 is achieved by means of a mix conveyer 27, which comprises a feed Collection Vibratory Conveyor and which is available from General Kinematics. The blender 22 is purged with Argon gas from the main supply tank 32A.

The chromite ore is dried in a dryer 29 before being supplied to the chromite ore feed bin 50. The dryer 29 basically comprises an Indirect Gas Fired Tube Dryer and which is available from L Haberny Company. Off-gases, dust and other particulates produced by the heating of the chromite ore in the dryer exit through an exhaust duct and are carried by conduits to the gas cleaning and recirculating system 30. That system basically comprises a bag house 30A and a dust recycle bin 30B.

The blender is a conventional device (e.g., like that available from Kelly Duplex Mill & Manufacturing Co.) and is configured to mix the feed materials together and provide the mixed feed materials to the blended feed day bin 24. The blender is supplied with Argon gas (purged at low volumetric flow rate) to displace air (oxygen and nitrogen) entrained in the feed materials. The blended feed day bin 24 is a conventional device (e.g., like that available from Coperion K-Tron) and is configured to store the feed mix materials and feed them at a controlled rate into the dispensing vessels of feed mix materials injection system 25. To that end, a weigh scale (not shown) is used with the blended feed day bin so that the amount of feed materials fed to the furnace 100 can be controlled by a controller (not shown). When the mix of feed materials, now designated by the reference number 14, is injected into the furnace 100 from a feed injection line and the furnace is operated the aluminum granules act as a reducing agent to produce an exothermic reaction reducing the oxygen in chromium oxide and iron oxides of the chromite ore to produce molten low carbon ferrochrome metal with molten slag floating on top of the molten low carbon ferrochrome metal. The molten slag produced by the exothermic reaction of the aluminum with the chromite ore results in aluminum oxide reporting to the slag, with negligible amounts of aluminum reporting to the low carbon ferrochrome metal.

As mentioned above the subject invention entails the production of low carbon ferrochrome by an aluminothermic process or technique, i.e., aluminothermic reduction (ATR). In particular, the reduction reaction proceeds as per the following reaction equation:

$$\frac{2}{3} < {Cr}_{2} {O}_{3} > + \frac{4}{3} < Al >= \frac{4}{3} < Cr > + \frac{2}{3} < {Al}_{2} {O}_{3} > \\ Δ {G}^{o} = - 309 + 0.004 T kJ$$

The amount of heat generated per unit mass of the reactants for the aforesaid reaction is 2649 kJ/kg. It is sufficiently higher than that required by other known low carbon ferrochrome processes. As is known ATR is a more effective and easier process as compared to silicothermic reduction. High refractory slag (Al₂O₃+Cr₂O₃) having high melting point can be kept fluid by making use of a flux, such as burnt lime (CaO content >95%) in the charge input mix. This will improve the recovery of low carbon ferrochrome metal. Excess use of pyrophoric aluminium should be avoided. Thermodynamic calculations on the above reaction and input mix of 70% chromite ore, 20% aluminium granules and 10% burnt lime flux, at 1800° C., predict a split between low carbon ferrochrome metal and slag of 29.5% metal and 70.5% slag, respectively.

In accordance with one preferred aspect of this invention, the amount of aluminum granules used in the mixture of feed mix materials is determined through thermochemical calculations to maximize the amount of chromium oxide that is reduced from a given chromite ore, thus maximizing the amount of chromium in the ferrochrome, whilst minimizing the amount of silicon and aluminum in the ferrochrome. Moreover, it is preferably that the process is a continuous process with the feed rate of the feed mix materials or reactants and the power supply input of the plasma electrode in the plasma arc furnace being controlled by the power-to-feed ratio controller (not shown) to ensure that the molten phase will not cool down excessively if the feed rate of the feed materials is altered to alter the rate of exothermic reaction.

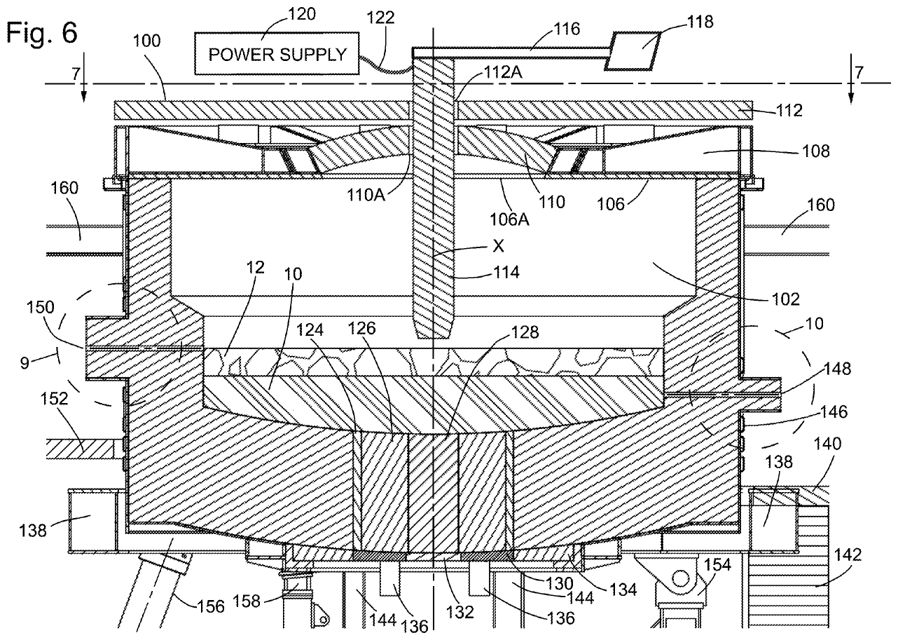

In the exemplary embodiment of system 20 shown in FIGS. 1A and 1B, the DC plasma arc furnace 100 is an electric arc furnace constructed in accordance with one aspect of this invention. FIG. 6 is a somewhat simplified vertical sectional view of the furnace 100. The furnace 100 includes a chamber 102 into which the feed materials are fed and where the exothermic reaction takes place to result in the reduction of the chromium oxide and the iron oxides in the chromite ore by the aluminum in the aluminum granules. The chamber is formed by between a roof and the walls and base of a conductive thermal refractory housing or body 104. Preferably the housing is made up of a suitable high temperature resistant and chemical attack resistant refractory lining to ensure the integrity of the DC plasma arc furnace and containment of the molten metal and slag materials in the furnace.

The top or roof of the furnace is composed of a refractory roof liner 106, roof panels 108, a central dome 110 and a roof platform 112. The liner 106 is a planar body formed of high alumina (Al₂O₃)-chrome oxide (Cr₂O₃) refractory and closes off the top of the chamber 102 except for a central opening 106A in the liner. The roof panels 108 are in the form of hollow ductwork formed of high alumina (Al₂O₃)-chrome oxide (Cr₂O₃) castable and are disposed above the liner 106. The roof panels 108 have a central opening 108A corresponding generally is size and shape to the central opening in the liner in which the central dome 110 is located. The central dome is formed of high alumina (Al₂O₃)-chrome oxide (Cr₂O₃) bricks and includes a central opening 110A. The roof platform 112 is disposed over the roof panels 108 and the central dome 110 and is a planar body formed of grated steel. The roof platform includes a central opening 112A. The central opening 112A is configured to closely receive a portion of an elongated cathode electrode 114 extending therethrough, whereupon a slight gap results between the outer surface of the portion of the cathode electrode and the inner surface of the opening 112A.

The cathode anode described in detail later. Suffice it for now to state that it is a cylindrical member that extends along the vertically oriented longitudinally extending central axis X of the furnace. The central opening 110A in the central dome is also configured to closely receive a portion of an elongated cathode electrode 114 extending therethrough, whereupon a slight gap results between the outer surface of the portion of the cathode electrode and the inner surface of the opening 110A. The cathode electrode is supported and held extending into the chamber by an arm 116 coupled to an electrode regulation system 118 which is configured to raise and lower the electrode along the axis X with respect to the bottom of the chamber, whereupon the spacing between the bottom of the cathode electrode and the bottom of the chamber can be adjusted as desired, and as will be explained later. The cathode electrode 114 is electrically connected to an electrical power source via a flexible copper bus 122. The electrical power source includes a rectifier having a negative pole to which one end of the bus 122 is electrically connected. The opposite end of the bus 122 is electrically connected to the upper end portion of the cathode electrode.

The bottom portion of the chamber 102 forms what can be called the furnace's hearth, where a bath of molten low carbon ferrochrome with a layer of slag floating on top thereof result from the operation of the arc furnace 100. The layer of molten low carbon ferrochrome is located at the bottom of the chamber 102 and is designated by the reference number 10, with the layer of slag floating thereon being designated by the reference number 12.

The central portion of the bottom of the refractory housing or body 104 includes an electrical isolation cylindrical sleeve 124 formed of high alumina (Al₂O₃) ramming material surrounding an annulus 126 of an electrically conductive hearth refractory material. The annulus 126 in turn surrounds a column 128 of an electrically non-conductive hearth refractory. An electrical return water-cooled anode disc 130 formed of copper is disposed under and in engagement with the undersurface of the sleeve 124 and the undersurface of the electrically conductive annulus 126, so that it is in electrical engagement with the annulus 126 but electrically isolated from the conductive refractory body making up the base of the housing. The anode disc 130 includes a central opening in which a support disc 132 is located. The support disc is formed of steel is in engagement with the undersurface of the electrically non-conductive hearth refractory column 128. The anode 130 is held in place under the bottom of the furnace's housing or body 104 by a steel support member 134. Electrical power for the anode is provided by electrically conductive bus bar bolting flanges 136 formed of copper. The electrical power for the anode is provided from the power source 120 via electrical connectors (not shown) to the bus bar bolting flanges 136.

The furnace's housing or body 104 is itself supported on the floor of the building in which it is located by a support frame 138. Disposed under the furnace are forced air cooling ducts 144 which extend to the hearth region of the furnace to cool it. Moreover, a cooling shell 146, including water cooling channels, extends about the lower portion of the housing to cool the hearth region.

Two tapholes 148 and 150 are provided in the furnace's housing to tap the molten low carbon ferrochrome and the molten slag from the furnace's chamber. The taphole 148 forms taphole from which the molten low carbon ferrochrome 10 is tapped to exit the furnace and thus is at the elevation with respect to the chamber 102 where the bath of molten low carbon ferrochrome will be produced. The taphole 150 forms the taphole from which the molten slag 12 is tapped to exit the furnace and thus is at the elevation with respect to the chamber 102 where the bath of molten slag will be produced, whereupon the molten slag taphole 150 is located above the height of the molten low carbon ferrochrome taphole 148.

A platform extends about the lower portion of the housing of the furnace, with a portion 140 located adjacent the molten low carbon ferrochrome taphole 148 to provide service personnel access to portions of the housing and the molten low carbon ferrochrome taphole 148. A flight of stairs 142 extends to the platform from the ground or other surface of the building in which the furnace is located. The platform includes another portion 152 to provide those service personnel access to other portions of the housing and to the molten slag taphole 150.

The furnace is configured to be tilted from its normal vertically oriented operating position or state, like shown in FIG. 6, to a tilted state (not shown) at which the central longitudinal axis X of the furnace extends at an acute angle, e.g., up to a maximum of approximately 7°, with respect to a vertical axis. The tilt ability of the furnace to the tilted state is provided so that flow of the molten low carbon ferrochrome and the molten slag to their respective tapholes can be expedited when desired or necessary, e.g., allowing controlled emptying of the furnace contents in case of an emergency and controlled emptying of slag when slag content in the furnace is at a level higher than the slag taphole. To that end, the furnace includes a furnace tilting pivot column 154 and a furnace tilting cylinder 156 each of which are coupled to the support frame 138. The pivot column 154 forms the fixed point about which the furnace can be tilted by the operation of the furnace tilting cylinder 156. A locking device 158 in the form of a hydraulically operated pin is provided to lock the furnace in its normal vertically oriented operating position.

Rails 160 are provided on the housing for holding taphole equipment, such as drills, mudguns and other tools for opening and closing the tapholes 148 and 150.

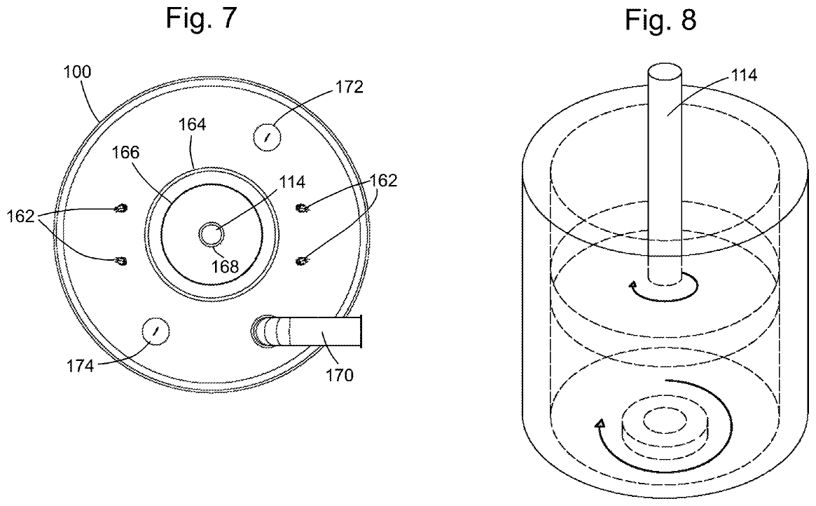

Turning to FIG. 7 the construction of the top portion of the furnace will now be described. As can be seen, the furnace includes four feed mix injection ports 162, a roof panel water cooled support ring 164, a roof dome water cooled support ring 166, an electrode port with electrode gas seal 168, a furnace gas exit porting 170, an inspection port with hatch 172, and a sampling/sounding port with hatch 174. The injection ports carry the feed material mix 14 from the material feed injection system 25 into the interior of the chamber 102 at the top portion thereof. The inspection port with hatch 172 provides access to the interior of the chamber 102 for inspection thereof by operating/service personnel. The sampling/sounding port with hatch 174 provides access to the interior of the chamber for depth measurements.

The roof panel water-cooled support ring 164 basically comprises a mild steel closed channel and serves to support the roof panels where these attach to the water-cooled roof ring and it supports the dome bricks forming the dome. The interface between the water-cooled support ring 164 and the first ring of the bricks that form the dome is designated by the reference number 166. To enable the free movement of the electrode 114 a gap 168 is provided between the outer surface of the electrode and the inner surface of the last ring of the dome bricks. The gap 168 is aligned with the central opening 112A in the roof platform 112.

In operation the chamber 102 is filled with Argon gas which is used as the carrier gas to inject the feed mix materials 14 into the chamber via the four feed mix injection ports 162. In addition, an inert gas purge e.g., Argon gas under positive pressure of at least 0.2 inch to 0.4 inch water gauge (50 Pa to 100 Pa) above atmospheric pressure, is introduced to prevent air ingress into the furnace through the roof ports and to exclude nitrogen and oxygen from the chemical process in the furnace.

As will be described in detail later, when electrical power is provided from the power supply 120 to the cathode electrode and the anode electrode and the cathode electrode is moved to its desired position with respect to the anode, a plasma arc is produced at the tip of the cathode electrode to initiate an exothermic reaction of the mix 14 within the chamber. This action results in the production of molten low carbon ferrochrome metal 10 in a bath at the bottom (e.g., the hearth) of the chamber 102, with lower density molten slag 12 floating on top of the higher density molten low carbon ferrochrome 10. The function of the plasma “electrical arc” is to control furnace and slag temperature to desired ranges, e.g., 1,660\ddot{ } 8 C to 1850\ddot{ } 8 C, to maintain a suitably fluid slag layer into which the reagents or feed mix materials are injected and reacting.

In accordance with one preferred aspect of this invention a controlled and controllable constant DC output power is provided from the power supply 120 to the electrically isolated DC arc graphite electrode 114 to initiate and maintain a plasma arc to supplement the exothermic heat generated from the chemical reaction in the chamber to maintain the molten metal and slag material bath in the chamber. The length of the arc below the tip of the DC graphite cathode electrode with respect to the molten slag and mixed feed materials introduced by injection into the furnace, is established until a desired electrical resistance is established to maintain the molten material bath in the chamber, with the electrical resistance being the sum of the resistance of the open DC plasma arc above the molten slag material bath, and the resistance of the plasma arc in the molten slag and, to a lesser degree, metal materials bath. The molten material bath is stirred, with the stirring resulting from the aluminothermic reaction, the current flowing through the molten material bath producing joule heating coupled with a magnetic effect of current flow through the molten bath to cause a local ripple effect or stirring motion in the molten material bath. This stirring action is illustrated in FIG. 8 and will be described later. The Argon gas atmosphere maintained inside the furnace free board (i.e., the open space inside the furnace above the molten slag) ensures that the aluminum reagent does not react with gaseous nitrogen and oxygen before entering the slag layer and that chromium oxide in any process reactions generated fume from the furnace is not oxidized to hexavalent chromium form.

As best seen in FIG. 7, the DC plasma arc furnace 100 also has an exit off-gas port 170 through which Argon gas and other process reactions generated off-gas fumes and dust particles produced within the furnace during operation of the furnace exit from the furnace. This dust is collected in the gas cleaning system 30, from where the dust retained in the gas cleaning system is returned to the chromite ore dryer 29 to be reintroduced or recycled to the dried chromite ore feed bin 74 from where it is transferred to the furnace dried chromite ore feed silo 50.

In accordance with one preferred aspect of the system of this invention, includes a single graphite plasma transferred arc cathode electrode 114 and a single conductive hearth and anode, which as stated above is made up of a conductive refractory annulus 126 and an electrical return water-cooled copper anode 130. As clearly shown in FIG. 6 the conductive refractory annulus is embedded in the center of the hearth refractory and is installed onto a water-cooled external copper anode 130.

The cathode electrode extends through the top or refractory roof dome 110 of the furnace and into to the chamber 102. The cathode electrode 114 is positioned in the center of the roof refractory dome 110 to ensure electrical isolation with the rest of the furnace roof. The cathode electrode 114 is powered from a controlled AC power transformer and DC rectifier, collectively known as a “rectiformer” or furnace power supply 120.

The cathode electrode 114 may be formed of graphite and as mentioned earlier is a cylindrical member. In particular, in accordance with one preferred aspect of this invention it is made up of plural circular sections with threaded nipple connections so that additional electrode sections may be joined to the graphite electrode section(s) already installed and used in the furnace as the tip of the graphite section in use are consumed due to the extremely high temperature of the plasma electric arc.

Cooling water for the shell 146 and roof 108 of the furnace is provided from a furnace water cooling device, such as an air-cooled heat exchanger or cooling tower (not shown). The external or copper dish return electrical anode 130 is positioned at the bottom of the furnace underneath the conductive hearth refractories, which forms the cradle or bath in which the molten low carbon ferrochrome metal 10 and the molten slag 12 are produced and accumulated.

As is known, slag formulations, with an aggressive composition, have a severe detrimental effect on refractory materials making up an arc furnace. Even under the condition of “static” slag and moderate temperature, erosion rates are severe and catastrophic failure may soon occur. The combination of the aggressive slag and the stirring of the slag, at elevated temperature, through the exit (e.g., outlet taphole) of the furnace create an extremely difficult challenge to the refractory lining design and selected refractory materials. This is typically resolved by using a replaceable taphole refractory block or preferentially by using a water-cooled slag refractory lined discharge external “mickey” block. The disadvantages of the water-cooled discharge block are two-fold. First, it is difficult to start the flow of slag even with a substantial “head” of liquid slag inside the furnace. Second, it is difficult to maintain an adequate flow of slag as the “head” of slag in the furnace diminishes.

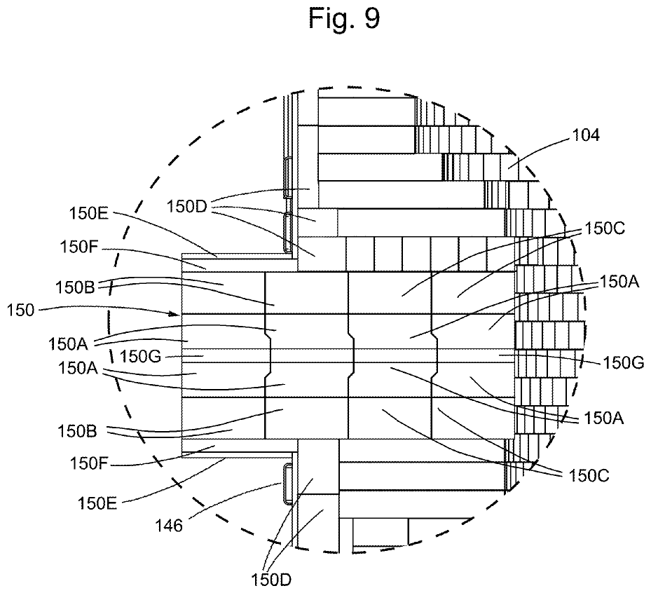

In accordance with one preferred aspect of the method of this invention, the molten low carbon ferrochrome and the molten slag are extracted intermittently and continuously, respectively, through their respective slag tapholes, 148 and 150. The construction of the upper or slag outlet taphole 150 is best seen in FIG. 9 and basically comprises an assembly of Magnesium Oxide-Chrome Oxide tap-blocks 150A, an assembly of High-Alumina surround bricks 150B, an assembly of Magnesium Oxide Chrome Oxide surround bricks 150C, a plurality of graphite tiles 150D, an external steel casing 150E, and a ramming material interface 150F. The Magnesium Oxide-Chrome Oxide tap-blocks 150A include a central passageway 105G through which the molten slag flows to exit the taphole 150. The surround bricks 150B and 150C surround the tap-blocks 150, with the surround blocks being located contiguous with the outlet of the taphole 150. The outlet of the taphole 150 includes the external steel casing 150E, which is water-cooled. A thermally insulating, e.g., 1,600\ddot{ } 8 C, ramming material is provided in the interface between the taphole casing 150E and the surround brick 150B to ensure good contact between the refractory surround bricks and the steel casing. The surround bricks are thermally conductive to allow heat to dissipate from the tap-blocks 150. The graphite tiles are provided for increased heat transfer between the furnace housing or body 104 in the critical cooling areas and the furnace steel shell.

The operation of the slag taphole assembly enables the slag 12 to flow continuously from the furnace 100 to maintain a constant thickness of molten slag within the furnace.

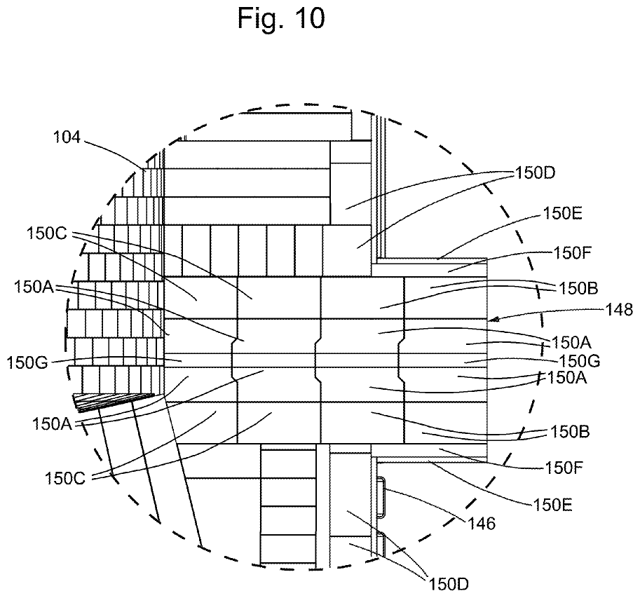

The construction of the lower or low carbon ferrochrome outlet taphole 148 is best seen in FIG. 10 and is identical in construction to the slag outlet taphole 150. Thus, in the interest of brevity the common components making up the low carbon ferrochrome outlet tap hole and the slag taphole will be given the same reference numbers and the details of their construction, arrangement and function will not be reiterated.

By operating the furnace with a nitrogen and oxygen-free free board atmosphere, the aluminum does not react prior to entering the molten slag layer. The exothermic reactions of the aluminum with the chromite ore in the slag layer thereby heat the slag and metal layers. The purpose of the plasma heating is to maintain the temperature of the slag layer formed from the slag making oxides in the chromite spinel and the lime flux added in the feed mixture. An additional purpose of the DC plasma heating is to maintain the temperature of the slag layer to ensure a sufficiently fluid or low viscosity slag so that the slag flows readily and continuously through the slag taphole 150, thus preventing solidification of the slag in the slag taphole. The heat from the DC plasma arc also offset the heat losses through the furnace refractory lining and water-cooling systems that are an integral part of the DC plasma furnace.

As best seen in the illustration of FIG. 8 electrical current flowing from the plasma electric arc through the molten slag bath provides “Joule heating” from the resistance between the electrical current flowing through the molten resistive slag causing an increase in temperature in the immediate local area of slag underneath the electrode. This increase in temperature due to Joule heating decreases the viscosity of the slag in the local area underneath the electrode. This effect combined with the induced magnetic field or “Corkscrew” effect causes a rotational effect on the volume of lower viscosity molten slag in the immediate local area underneath the electrode or in the arc attachment zone. This continuously rotating volume of molten slag contains reacting and reduced metallic particles of aluminum and ferrochrome metal (metallic “prills”). These are fine metallic particles of formed low carbon ferrochrome which have not yet settled to the metal bath below the slag, and which are still suspended in the molten slag—the lower the slag viscosity the lower the concentration of prills in the molten slag—prills settle (migrate) faster to the metal bath—the higher metal yield and chrome recovery.

Voltage of the are will vary depending upon the total resistance of the electrical path consisting of the arc length in the Argon gas atmosphere above the molten slag melt (free board), slag layer resistance and the metal bath layer resistance. It should be noted that the slag layer is also flowing towards and out of the furnace through the slag taphole 150 causing continual movement of the slag.

Turning now to FIG. 1B, the detailed paths of the gases/dust and other particulate through the components of the system 20 is shown by the arrow-headed lines in FIG. 1B and will now be described. Thus, as will be seen, the recycled Argon gas, which is used to inject the feed mix materials into the DC plasma arc furnace, is provided from recycled Argon tank 32B. Once the feed mix materials are delivered to the furnace molten slag layer, the dust loaded Argon gas is returned through the furnace gaseous free board, furnace roof off-gas port and an external, to the furnace, gas scrubber 44, which is a water-cooled off-gas duct and dry gas cooling and cleaning system. That system is used to remove solid materials and other gaseous phases from the ejected furnace off-gas. One particular gas scrubber 44 is designed by and available from Lange USA. The cleaned furnace off-gas from the gas scrubber is then recycled to the Recycled Argon Tank 32B, for reuse as feed mix injection gas in the next cycle of feed mix materials injection into the DC plasma arc furnace. The recycled Argon gas is also used to create air/gas seals to the furnace, for example the electrode seal, i.e., the seal of any gaps or spaces between the outer surface of the electrode 114 and the components of the furnace through which the electrode extends. Clean Argon gas from the Main Argon Supply Tank 32A is provided as purge gas to various locations, e.g., the feed material silos 50, 52, 56 and 58, and to top-up gas to the Recycled Argon Supply Tank 32B to make up for Argon gas losses from the closed Recycled Argon Supply Tank and Feed Mix Injection circuit.

It must be pointed out at this juncture that the construction of the furnace electrode and associated electrical components, as well as the mode of operation of the cathode electrode to achieve advantageous stirring is not limited to the production of low carbon ferrochrome metal in a DC plasma arc furnace. Thus, the construction and method of use of the cathode electrode for stirring slag and metal layers in a DC plasma arc furnace can be used to advantageously produce various other types of metals and alloys in a DC plasma arc furnace.

As mentioned earlier the electrically isolated DC transferred arc graphite electrode 114 extends vertically through the roof refractory dome 130 of the plasma furnace 100. The electrode 114 is fitted with independent height control so that the position of the electrode section above the molten slag material bath can be controlled. To that end, the furnace 100 is provided with a vertical hydraulically operated support column, incorporating a movable horizontal arm 116 that includes an electrically isolated copper clamping mechanism (not shown) for holding and altering the vertical position of the cathode electrode 114 and providing a connection clamp for the supply of electricity from the power supply 120 to the cathode electrode. The electrode arm, the electrode clamping mechanism and the electricity supply clamp of the support column is configured to be moved in a vertical direction to raise or lower the cathode electrode.

As also mentioned earlier the cathode electrode 114 is a cylindrical or rod-like member comprising an assembly, e.g., two to three electrode sections joined together. The raising or lower of the cathode is provided to adjust the arc length and to account for ablation and erosion of the graphite by the electrical arc from the tip of the electrode assembly to the slag bath. As also mentioned earlier, the electrode section is machined with internal and external threading at the ends so that additional graphite sections may be joined thereto from the top as the tip of the graphite electrode section closest to the slag bath is consumed due to the high temperatures of the plasma electrical arc. This feature enables continuous operation of the electrode and furnace, only with short intermittent stoppages to join new electrode sections. The additional electrode sections may be connected to the electrode assembly in use, by using a movable jib crane arrangement.

The DC plasma arc power supply 120 for the cathode electrode 114 provides a controlled and controllable constant power supply at a selected resistance setpoint, with the voltage and current being allowed to vary depending on the actual real-time and instantaneous “arc” resistance of the process, relative to the desired setpoint resistance. The “are” resistance is the sum of the resistances in the open arc and the resistance in the molten slag bath. The direct current power supply output is connected as a single negative common point to the electrical supply electrode and a single positive common point to the electrical return copper anode. The external electrical return copper anode 130 as discussed above may be a water-cooled copper dish that is installed at the bottom of the furnace underneath the conductive hearth refractory, which is also electrically conducting, to make contact with the metal layer, e.g., the molten ferrochrome metal, of the bath and thereby complete the electrical circuit through the metal and slag layers of the bath to the graphite cathode electrode. The electrical return copper anode terminations to the water-cooled copper dish, as well as the copper dish itself, are water-cooled to prevent electrical resistance overheating.

Initiating the plasma are can be carried out in a specific way in accordance with the method of this invention. The furnace is started up, i.e., energizing the power supply 120 and then lowering the cathode electrode 114 into the furnace's chamber 102 to contact what can be called the hearth electrical return anode. That anode is formed by a layer of low carbon ferrochrome metal 10 in contact or covering the electrical return conductive hearth refractory 126 and the return copper anode 130. To ensure that there will be a layer of low carbon ferrochrome metal in contact or covering the hearth electrical return anode prior to the initial start-up, pieces of low carbon ferrochrome metal can be placed in the bottom of the furnace so that the plasma arc will form a molten layer of metal in contact with the top portion of the electrically conductive refractory and electrical return copper anode. One of the ways of initiating the plasma are entails selecting a “Setpoint Power” value together with “Plasma On” setting on the plasma power supply 120 also referred to as a “closed circuit”—only electrical current flowing. Ignition of the arc is then achieved by raising the electrode until a satisfactory power input is established, which is also referred to as an “open circuit”—electrical current flow and voltage potential is established between the two open ends.

The feed materials of the mix 14 are introduced into the furnace chamber 102 through the furnace feed mix materials injection ports 162, of which there are four, as best seen in FIG. 8. As can be seen those ports are in the water-cooled refractory-lined roof panels 108 and are arranged on the outside of the roof refractory dome 110.

As best seen in FIG. 1A, the low carbon ferrochromium metal 10 is intermittently tapped from the furnace directly onto the hot metal launder 34 and subsequently into a hot metal transfer tundish (not shown) into the metal ingot caster 36. At the completion of tapping the low carbon ferrochromium metal from the furnace, the low carbon ferrochromium metal taphole 148 is plugged with a refractory mixture or taphole clay of composition designed for this purpose.

The covered hot metal launder 34 is a conventional device (e.g., like that available from Economy Industrial, LLC) and is configured to receive the molten low carbon ferrochromium metal onto it directly from the furnace metal taphole 148. The molten metal is introduced from the launder into a transfer tundish from where it is introduced without splashing into the metal ingot caster 36. The metal ingot caster 36 is a conventional ingot casting machine (e.g., like that available from Economy Industrial, LLC). It basically comprises a plurality of cast iron or steel alloy molds 36A on a continuous belt conveyor 36B and is configured to collect the molten low carbon ferrochrome into the molds 36A on the conveyor 36B to form respective low carbon ferrochromium metal ingots and quench those ingots with water from a water source (e.g., spray) 36C, whereupon the ingots solidify. The solidified ingots drop into the metal ingot crusher 38 receiving bin (not shown) at the discharge end of the caster, which is then transferred to the crusher, where the contents are charged from the receiving bin into the metal ingot crusher 38. That metal ingot crusher includes at least one movable jaw 38A which crushes the ingots to form crushed coarse pieces or smaller particles which are discharged onto a screen 40. The metal ingot crusher 38 is a conventional apparatus (e.g., like the Pennsylvania Crusher double toggle jaw crusher available from TerraSource Global). The crushed low carbon ferrochromium materials, which are of a specific predetermined size, e.g., approximately above 6 mm, form the final low carbon ferrochromium metal product of this invention, i.e., the ferrochrome product. That product can be charged to a product collecting bin (not shown) which is a conventional fabricated device and is configured to hold the screened ferrochrome product until this is desired to be dispensed either as large batches onto trucks or small batches into bags which may be transported to a steel mill or foundry, depending upon the specific end use for the low carbon ferrochrome metal product.

The crushed particles of low carbon ferrochrome exiting the metal ingot crusher 38, which are smaller in size than 6 mm, are hereinafter referred to as “fines”. The fines or screened undersize materials are discharged from the screen 40 into the recycling bin 42 from where they are reintroduced into the ingot molds 36A prior to addition of the next molten low carbon ferrochrome, whereupon they mix with the molten low carbon ferrochrome that is subsequently introduced therein from the hot metal launder 34. The fines or screened undersize materials are discharged from the screen 40 into the recycling bin 42 from where they are reintroduced into the crusher 38.

It should be noted that while the use of the fines in this manner is preferred, it is also contemplated that the fines from the recycling bin could be recycled with the recycled materials 56 of the feed materials to the blender 22 for mixing with the other feed materials for introduction into the furnace 28. In such a case, the fines when introduced into the furnace, drop through the molten slag and into the molten ferrochrome, where fines melt into the molten ferrochrome. In either case the fines are recaptured in the ferrochrome product. Moreover, it is also contemplated that the fines may be introduced into the ingot molds 36A whereupon they mix with the molten low carbon ferrochrome that is introduced therein from the hot metal launder 34. That action may minimize the fines load to the crusher 38 when the system 20 is operating at full capacity.

While the ferrochrome product is preferably formed by use of the ingot molds 36 and the metal ingot crusher 38 as just described, it is contemplated that it can be produced by other means, e.g., by granulating a stream of molten ferrochrome metal in water in a ferrochrome granulation tank (not shown) and associated dryer (not shown). One such granulating system is available from UHT, Kista, Sweden. In such a case, the molten low carbon ferrochrome is carried by the hot metal launder 34 to the ferrochrome granulation tank (not shown). The ferrochrome granulation tank is configured to break the molten low carbon ferrochrome into fine droplets and to rapidly quench those droplets with water provided from an inlet water source, whereupon the droplets solidify. The solidified droplets are transported from the ferrochrome granulation tank onto a screen (not shown, but similar to the described screen 40). Those ferrochrome granules which are greater in size than 6 mm are carried from the screen (not shown) for introduction into a dryer (not shown), whereupon the heat provided within the dryer removes any residual water on those granules resulting from their quenching in the ferrochrome granulation tank. The dryer is a conventional device (e.g., like that available from UHT, Kista, Sweden.). The dried low carbon ferrochrome granules that exit the dryer form the ferrochrome product granules, which are carried to the collecting bin (not shown, but similar to the bin described earlier).

A site or plant constructed in accordance with the exemplary system 20 for carrying out the process of this invention is preferably completely self-contained or enclosed in a building. In particular, the only materials produced from the process of this invention that exit the plant are the heretofore mentioned two products, namely, the ferrochrome product and the slag product. Everything else, e.g., the dust from the furnace (which may contain chromium oxides), and any spillage of materials within the material handling portion of the system 20 are provided back to the blender 22 as the recycled materials 56. The Argon gas is cleaned and recirculated to be used again in the feed mix materials injection system. These actions render the method of this invention not only economic, but environmentally protective.

As mentioned above, it is from the upper outlet port or taphole 150 of the furnace 100 that the molten slag 12 produced by the method of this invention flows when that taphole is opened. In particular, the molten slag is provided into an inlet port of the slag quench conveyor (wet quench process) 46. The slag quench conveyor 46 is a conventional device (e.g., like that available from General Kinematics) and is configured to break the molten slag into “popcorn-sized” particles and droplets and to rapidly quench those droplets with water provided from an inlet water source (not shown). This action results in the formation of slag particles. This method produces slag particles of a suitable size, e.g., in the range of approximately 3 mm to 8 mm for use as an aggregate in construction or for use in the production of cement.

The slag product particles are transferred from the slag quench conveyor discharge via a series of belt conveyors and charged to the quenched slag product collecting bin or slag silo 48. The slag product in the slag product silo is then discharged as bulk loads or batches directly from the silo bottom discharge into trucks or bags.

The chemistry of the slag formed by the method/process of this invention is critical to the commercial viability of that method/process. In this regard, it is desirable to minimize the melting point of the slag while maximizing its fluidity to enable it to readily flow out of the furnace. Thus, the method of this invention entails optimizing the chemistry of the slag to enhance its fluidity at the selected operating temperature. To that end, the amount of burnt limestone added to the process is controlled based on the amount of magnesium oxide, aluminum oxide and silicon dioxide that is in the chromite mineral or chromite ore. For example, if the chromite mineral is high in silica, then the process will require the addition of more burnt limestone. If the chromite ore is low in silica, then the process will use less burnt limestone. The melting point of the chromite minerals can be from 1,700° C. to 2000° C. The method/process of this invention entails utilizing the lowest possible temperature for the melting point which will result in the maximum slag fluidity and maximum chromium recovery. The composition of the slag will not have any effect on the exothermic reaction reducing the chromite ore to the low carbon ferrochrome metal but will influence the fluidity of the slag produced.

The chromium oxide and the iron oxides in the chromite ore are in the form of the mineral spinel. The exothermic reaction under stoichiometric conditions to reduce the oxygen out of the chromium oxide and the iron oxides may not produce enough heat to ensure that the whole mass of the feed materials becomes liquid. To ensure the reduction of chromium oxide and iron oxides is optimized, thermochemistry calculations (e.g., with Metso-Outotec's developed HSC chemical, thermodynamic, and mineral processing simulation software package and CRCT's developed FactSage chemical and thermodynamic computer software package) are used to predict the optimum ratios of the feed materials. In addition, the heat provided by the DC plasma electric arc furnace ensures that there is sufficient heat to smelt the entire mass of feed materials into a superheated bath of slag and molten metal.

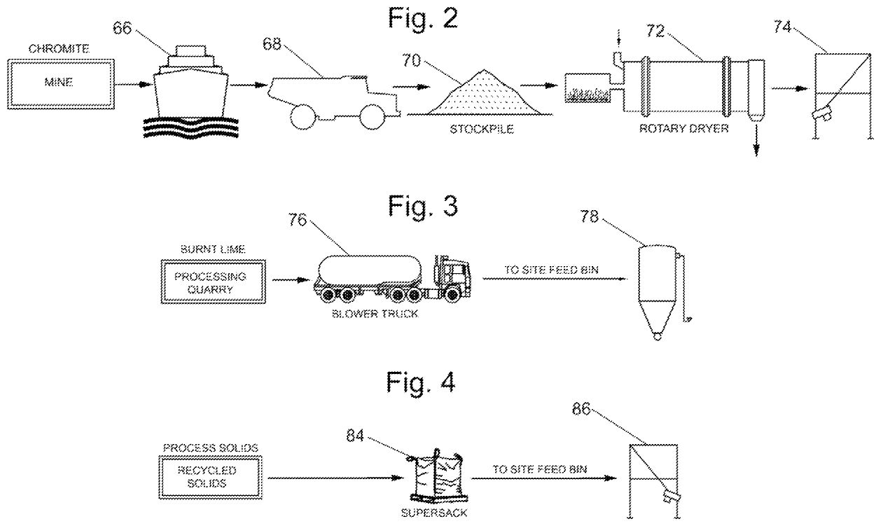

The chromite ore feed material 50 is stored in a feed bin on the site or plant at which the system 20 is located, and is provided from its initial source, e.g., a mine, as shown in FIG. 2. Thus, as can be seen in FIG. 2, the ore from a mine is transported by ship 66 (assuming that the mine is located across some large body of water requiring sea freight transportation) from where it is carried by truck 68 to a stockpile 70 at the site or plant for use in the system 20. The chromite ore is dried in a conventional rotary kiln dryer 72 and the dried chromite ore is then stored in a site located feed bin 74 ready for use in the process.

The burnt lime feed material 52 is also stored in a feed bin on the site or plant at which the system 20 is located, and is provided from its initial source, e.g., a processing quarry, as shown in FIG. 3. Thus, as can be seen in FIG. 3, the burnt lime from a processing quarry is transported by blower truck 76 to a site storage feed bin 78 at the site or plant of the system 20 ready for use.

The process solids from the cleaned furnace off-gas stream are also stored in a feed bin on the site or plant at which the system 20 is located, and are provided from the furnace off-gas scrubber 44, from where it can either be stored in a dust recycle bin 30B or as shown in FIG. 2 recycled directly to the rotary kiln dryer 72, and from the rotary kiln dryer to the recycling bin 86, via super sack 84, to the site feed bin 56 at the site or plant of the system 20 ready for use.

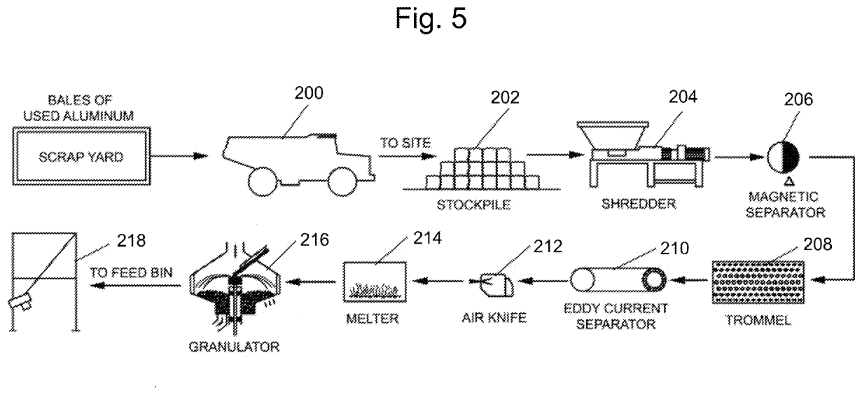

The aluminum granules 58 are stored on the site or plant at which the system 20 is located, and as shown in FIG. 1A. As best seen in FIG. 5, the aluminum granules are provided from a scrap yard in the form of bales of scrap aluminum. The bales are transported by truck 200 to the site where they are stored in a stockpile 202. From the stockpile the bales are broken up and fed to a conventional shredder 204 to release non-aluminum solid matter. The non-aluminum solid matter is then separated and cleaned via the shredder. The shredded scrap aluminum is provided to a conventional magnetic separator 206 to remove any magnetic particles. From there the scrap aluminum is provided to a conventional trommel 208 including a rotating screen to remove any dirt, liquids, and water. From there the aluminum scrap is passed through an eddy current separator 210 to remove any non-ferrous metals, wood and other trash. From there the aluminum scrap is provided to a conventional air knife 212 to remove any residual water, plastic, and paper. The cleaned scrap aluminum is then provided to a conventional melter 214 where it is melted in air to produce molten scrap aluminum. The molten scrap aluminum is then fed to a conventional granulator 216 where the molten aluminum is discharged onto a rotating perforated graphite cup to form molten aluminum droplets which are cooled in air as they fall and solidify into granules. Preferably the granules are in a size range of approximately 0.1 mm and 2.0 mm. The aluminum granules are then carried to a feed bin 222 at the site or plant where the system 20 is located ready for use.

It must be pointed out at this juncture that the system 20 and its components as described above is merely one exemplary embodiment of various systems that can be constructed in accordance with this invention to carry out the method or process of this invention. Moreover, the method described above is merely exemplary of various methods or processes for producing low carbon ferrochrome in accordance with this invention. Thus, for example, the system 20 may use steam in a heat exchanger to preheat Argon injection gas to reduce the smelting energy requirement in the furnace 100. Moreover, the ferrochrome fines may not be reused if such fines could be otherwise commercialized. So too, the dust particles from the DC plasma furnace off-gas stream, which are collected from the furnace off-gas cleaning and recirculating system may not be recycled to the recycling bin. Further still, other types of arc furnaces, granulation tanks and granulators, and other apparatus can be used in lieu of the exemplary furnace, metal ingot caster, metal ingot crusher, and the furnace off-gas cleaning and Argon recirculation system respectively. Other portions of the exemplary system 20 and the steps the exemplary method/process as described above can be eliminated, if desired, providing that the system and method/process makes use of aluminum granules as the exothermic source to reduce the chromium oxide and iron oxides in the chromite ore and to produce a slag which is sufficiently fluid to enable the formation of the low carbon ferrochrome metal to be carried out economically and which itself can be readily quenched into slag particles or granulated into slag granules for commercial use.

Without further elaboration the foregoing will so fully illustrate our invention that others may, by applying current or future knowledge, adopt the same for use under various conditions of service.

We claim:

1. A method for recovering low carbon ferrochrome metal from chromite ore comprising:
feeding a mixture of feed materials comprising aluminum granules, burnt lime, and chromite ore into a DC plasma arc furnace, said chromite ore containing chromium oxide and iron oxides, said feed materials being in a proportion as determined by thermochemical calculations for reduction of said chromium oxide and iron oxides to form low carbon ferrochrome metal;
heating said feed materials in said DC plasma arc furnace to a temperature in the range of approximately 1,660\ddot{ }8 C to 1850\ddot{ }8 C wherein said aluminum in said aluminum granules acts as a reducing agent to produce an exothermic reaction reducing said chromium oxide and iron oxides in said chromite ore to produce a bath of molten low carbon ferrochrome metal with molten slag floating on top of said molten low carbon ferrochrome metal; and
extracting said molten low carbon ferrochrome from said DC plasma are furnace.

2. The method of claim 1, additionally comprising extracting said molten slag from said DC plasma arc furnace and quenching or granulating said extracted molten slag into quenched slag conveyor particles or dry granulated particles of slag.

3. The method of claim 1, wherein said DC plasma arc furnace includes a single transferred arc electrode.

4. The method of claim 1, wherein said method is continuous.

5. The method of claim 1, wherein the amount of aluminum granules used in said mixture of feed materials is determined through thermochemistry calculations for the said chromite ore and iron oxides in said mixture of feed materials.

6. The method of claim 1, additionally comprising extracting molten slag from said DC plasma arc furnace at an outlet taphole.

7. The method of claim 1, wherein Argon gas under pressure higher than atmospheric pressure is provided into said DC plasma arc furnace to prevent nitrogen and oxygen in air from entering into said plasma arc furnace.

8. The method of claim 1, wherein Argon gas is used as a carrier gas to inject the feed mix materials into the said DC plasma arc furnace.

9. The method of claim 7, wherein said Argon gas is heated in a furnace freeboard area upon entering the furnace and wherein said Argon gas is at a pressure of at least 0.2 inch of water column (50 Pa) above atmospheric pressure.

10. The method of claim 9, wherein said heated Argon gas, after exiting the DC plasma arc furnace, is cooled, cleaned of solid materials and dust, other gaseous compounds, moisture, and recirculated for reuse into the DC plasma arc furnace.

11. The method of claim 1, wherein pieces of low carbon ferrochrome are provided as a start-up metal in said chamber to form said bath of molten low carbon ferrochrome metal with molten slag floating on top of said molten low carbon ferrochrome metal.

12. Low carbon ferrochrome produced by the method of claim 1.

13. A method of producing a metal or metal alloy from feed materials located within a chamber in a DC plasma arc furnace, wherein said metal or metal alloy comprises low carbon ferrochrome, said method comprising:
providing a single electrically isolated graphite electrode or cathode in said DC plasma are furnace above said feed materials in said chamber;
providing a controlled and controllable constant DC output power to said electrically isolated graphite electrode or cathode from a DC plasma power supply to initiate a DC plasma arc from said graphite electrode or cathode to heat said feed materials in said chamber to produce a molten material bath in said chamber;
establishing the height of a bottom of said graphite electrode or cathode with respect to a surface of said molten material bath in said chamber until a desired power is established to produce said molten material bath in said chamber, said power varying as a function of the feed rate of the feed mix materials; and
stirring of said molten material bath, said stirring resulting from current flowing through said molten material bath producing Joule heating coupled with a magnetic effect of current flow through said molten bath to cause a local ripple effect or stirring motion in said molten material bath.

14. The method of claim 13, wherein said initiating of said DC plasma arc is accomplished by energizing said DC plasma power supply, lowering said graphite electrode or cathode into said furnace to contact a layer of said metal or metal alloy covering an electrical return copper anode that supports an electrically conductive refractory hearth containing said molten material bath, and selecting a start power for application by said DC plasma power supplies to cause a flow of current, whereupon said graphite electrode or cathode is raised until said desired power is established.

15. The method of claim 13, additionally comprising providing pieces of said metal or metal alloy into said chamber where said molten material bath is located to form a molten layer of said metal or metal alloy in contact with said electrically conductive refractory hearth and return copper anode.

16. A metal or metal alloy produced by the method of claim 13.

17. A system for recovering low carbon ferrochrome metal from chromite ore comprising:
a source of aluminum granules that are low in magnesium and copper contents;
a source of burnt lime;
a source of chromite ore, said chromite ore containing chromium oxide and iron oxides;
a source of Argon gas;
a conveyor configured for carrying said aluminum granules, said burnt lime, and said chromite ore as a mix of feed materials to a chamber of a direct current (DC) plasma arc furnace via a feed materials injection system, said feed materials of said mix being in a proportion as determined by thermochemical calculations for reduction of said chromium oxide and iron oxides to form low carbon ferrochrome metal;
a conduit configured for carrying said Argon gas into said chamber via a feed materials injection system;
said direct current (DC) plasma arc furnace comprising a single transferred arc electrode or cathode electrode, an anode electrode, a direct current (DC) power supply, and a support holding said single transferred arc cathode electrode extending into said chamber, and over said anode electrode, said DC power supply being configured when said Argon gas is in said chamber to provide electrical power to said DC arc cathode electrode to produce a plasma arc thereby heating said feed materials in said chamber to a temperature in the range of approximately 1,660\ddot{ }8 C to 1850° C. wherein said aluminum in said aluminum granules acts as a reducing agent to produce an exothermic reaction reducing said chromium oxide and iron oxides in said chromite ore to produce a molten material bath in said chamber above said anode electrode, said molten material bath comprising molten low carbon ferrochrome metal with molten slag floating on top of said molten low carbon ferrochrome metal.

18. The system of claim 17, wherein said single transferred arc electrode or cathode is formed of graphite, and wherein said anode comprises an external anode system formed of copper and internal anode system formed of conductive refractory.

19. The system of claim 18, wherein said DC plasma arc furnace is configured so that said Argon gas acts as a carrier gas to inject said mix of feed materials into said chamber.

20. The system of claim 19, wherein said support holding said single transferred arc graphite electrode or cathode is configured to move said single transferred arc graphite electrode or cathode so that a portion extends into said chamber, said support being controllable for establishing the height of said single transferred arc graphite electrode or cathode with respect to said feed materials until a desired power is established to produce said molten material bath in said chamber, said power varying as a function of the feed rate at which said feed materials are introduced into said chamber by said Argon gas.

21. The system of claim 17, wherein said DC plasma arc furnace comprises a taphole from which said molten low carbon ferrochrome metal can be caused to flow, and wherein said system additionally comprises an ingot caster with plural moulds configured for casting said molten low carbon ferrochrome metal into plural ingots.

22. The system of claim 21, additionally comprising a crusher apparatus for breaking and crushing said ingots into smaller pieces of low carbon ferrochrome metal.

23. The system of claim 17, wherein said DC plasma arc furnace comprises a taphole from which said molten slag can be caused to flow, and wherein said system additionally comprises a water quencher configured for quenching said molten slag into quenched particles of slag.

24. The system of claim 19, wherein said Argon gas is provided under pressure higher than atmospheric pressure into said chamber to prevent air ingress into said chamber.

25. The system of claim 17, wherein said system additionally comprises apparatus configured for receipt of gases from said chamber to produce recycled Argon gas therefrom, and for providing said recycled Argon gas for reintroduction into said chamber.

26. The system of claim 25, wherein said apparatus comprises a scrubber.

27. The system of claim 17, wherein said arc furnace includes a hood and an associated conduit for collecting ejected furnace off-gas and other solid materials from said chamber and for carrying said solid materials to a dust recycling bin or other collector via said scrubber.

28. The system of claim 17, additionally comprising a dryer for drying said chromite ore.

29. The system of claim 17, additionally comprising a main Argon supply tank, and a recycled Argon supply tank, each of which is configured to provide said Argon gas to said system.

30. The system of claim 17, wherein said DC plasma arc furnace comprises a ferrochrome taphole from which said molten low carbon ferrochrome metal can be caused to flow, and a slag taphole from which said molten slag can be caused to flow, and wherein said DC plasma arc furnace is mounted on a tiltable support configured to allow said DC plasma arc furnace to tilt with respect to a vertical axis to enable controlled emptying of the chamber's contents.
